(19) United States
(12) Patent Application Publication
(10) Pub. No.: US 2020/0371774 A1
(43) Pub. Date: Nov. 26, 2020

(54) SOFTWARE UPDATING DEVICE AND SOFTWARE UPDATING METHOD

(71) Applicant: HONDA MOTOR CO., LTD., Tokyo (JP)

(72) Inventors: Hisato Kato, Wako-shi (JP); Yosuke Shionoya, Wako-shi (JP)

(21) Appl. No.: 16/877,532

(22) Filed: May 19, 2020

(30) Foreign Application Priority Data
May 22, 2019 (JP) 2019-096131

(51) Int. Cl. G06F 8/65; G06K 9/00; H04L 29/08

(52) U.S. Cl. CPC G06F 8/65; H04L 67/12; G06K 9/00832

(57) ABSTRACT

A software updating device according to one aspect includes: an apparatus controller in which software for controlling at least some of apparatuses mounted in a vehicle is installed; a communicator configured to communicate with an external device; an update controller configured to update the software installed in the apparatus controller according to communication with the external device through the communicator; and a communication state manager configured to manage a communication state between the communicator and the external device, wherein the update controller causes communication with the external device to be executed in an area in which communication has been performed in a communication state having a predetermined speed or higher from among past communication states managed by the communication state manager.

### CROSS-REFERENCE TO RELATED APPLICATION

Priority is claimed on Japanese Patent Application No. 2019-096131, filed May 22, 2019, the content of which is incorporated herein by reference.

### BACKGROUND

### Field of the Invention

The present invention relates to a software updating device and a software updating method.

### Description of Related Art

Conventionally, various systems for externally providing data to vehicles are known (for example, Japanese Patent No. 5970547). For example, a software updating device mounted in a vehicle may download an update program from a server device and apply the downloaded update program to software installed in a controller that controls apparatuses to update the software.

### SUMMARY

However, since the communication state of a vehicle changes when the vehicle is traveling, there are cases in which transmission and reception of data are not appropriately performed according to communication states.

An object of the present invention devised in view of such circumstances is to provide a software updating device and a software updating method which can perform transmission and reception of data in a more appropriate communication state.

A software updating device and a software updating method according to the present invention employ the following configurations.

(1): A software updating device according to an aspect of the present invention is a software updating device including: an apparatus controller in which software for controlling at least some of apparatuses mounted in a vehicle is installed; a communicator configured to communicate with an external device; an update controller configured to update the software installed in the apparatus controller according to communication with the external device through the communicator; and a communication state manager configured to manage a communication state between the communicator and the external device, wherein the update controller causes communication with the external device to be executed in an area in which communication has been performed in a communication state having a predetermined speed or higher from among past communication states managed by the communication state manager.

(2): In the aspect of (1), when a route to a destination of the vehicle has been set by a route guide configured to perform guidance for a route from a current position of the vehicle to a destination, the update controller sets a region in which communication for updating the software will be performed on the route.

(3): In the aspect of (1), the software updating device further includes an action predictor configured to perform prediction of a future action of the vehicle on the basis of past communication states managed by the communication state manager, wherein a region in which communication for updating the software will be performed is set on the basis of a future action of the vehicle predicted by the action predictor.

(4): In the aspect of (3), the action predictor estimates a state of an occupant of the vehicle from a captured image of the occupant and performs prediction of a future action of the vehicle on the basis of the estimated state of the occupant.

(5): In the aspect of (1), the software updating device further includes a position acquirer configured to acquire a position of the vehicle, wherein, when the vehicle is traveling at a position different from positional information included in the past communication states, the communication state manager learns a communication state of the different position on the basis of the position of the vehicle acquired by the position acquirer.

(6): In the aspect of (1), the communication state having the predetermined speed or higher includes communication using a communication method conforming to Wi-Fi.

(7): In the aspect of (1), when the communication state is communication using a communication method conforming to Wi-Fi at a specific point and the vehicle stops, the update controller performs communication for updating the software in preference to other communication states.

(8): In the aspect of (1), when the software to be updated is software having high urgency, the update controller performs communication with the external device irrespective of communication states and performs communication for updating the software.

(9): In the aspect of (1), the communicator performs communication with another vehicle present around the vehicle, and when information about a communication state surrounding the vehicle has been acquired from the other vehicle or the external device through the communicator, the update controller sets a region in which communication for updating the software will be performed on the basis of the acquired surrounding communication state.

(10): A software updating method according to an aspect of the present invention is a software updating method, using a computer which realizes a software updating device mounted in a vehicle, including: communicating with an external device; updating software installed in a controller configured to control at least some of apparatuses mounted in the vehicle through communication with the external device; managing a communication state with respect to the external device; and causing communication with the external device to be executed in an area in which communication has been performed in a communication state having a predetermined speed or higher from among managed past communication states.

According to the aspects of (1) to (10), it is possible to perform transmission and reception of data in a more appropriate communication state.

### BRIEF DESCRIPTION OF THE DRAWINGS

FIG. 1 is a configuration diagram of a vehicle system including a software updating device of a first embodiment.

FIG. 2 is a diagram showing an example of details of communication history information.

FIG. 3 is a diagram showing an example of details of software management information.

FIG. 4 is a diagram for describing processing of an update controller.

FIG. 5 is a diagram showing an example of details of communication schedule information.

FIG. 6 is a flowchart showing an example of processing of the software updating device of the first embodiment.

FIG. 7 is a configuration diagram of a vehicle system including a software updating device of a second embodiment.

FIG. 8 is a diagram for describing processing of an update controller.

FIG. 9 is a flowchart showing an example of processing of the software updating device of the second embodiment.

FIG. 10 is a diagram showing an example of a configuration of a software updating system including a software updating device according to a third embodiment.

FIG. 11 is a configuration diagram of a server device of the third embodiment.

FIG. 12 is a diagram showing an example of details of server side communication history information.

FIG. 13 is a diagram showing an example of a map generated by a map generator.

FIG. 14 is a flowchart showing an example of processing of the software updating device of the third embodiment.

FIG. 15 is a flowchart showing an example of map generation processing in the server device of the third embodiment.

FIG. 16 is a flowchart showing an example of map providing processing in the server device of the third embodiment.

### DESCRIPTION OF EMBODIMENTS

Hereinafter, embodiments of a software updating device, a server device, and a software updating method of the present invention will be described with reference to the drawings. An example in which a software updating device is mounted in a vehicle as a part of a vehicle system will be described below. A vehicle is, for example, a two-wheeled, three-wheeled, four-wheeled vehicle, or the like and a driving source thereof includes an internal combustion engine such as a diesel engine or a gasoline engine, a motor or a combination thereof. The motor operates using power generated by a generator connected to the internal combustion engine or power discharged from a secondary battery or a fuel battery. The software updating device may be mounted in a moving body other than vehicles.

### First Embodiment

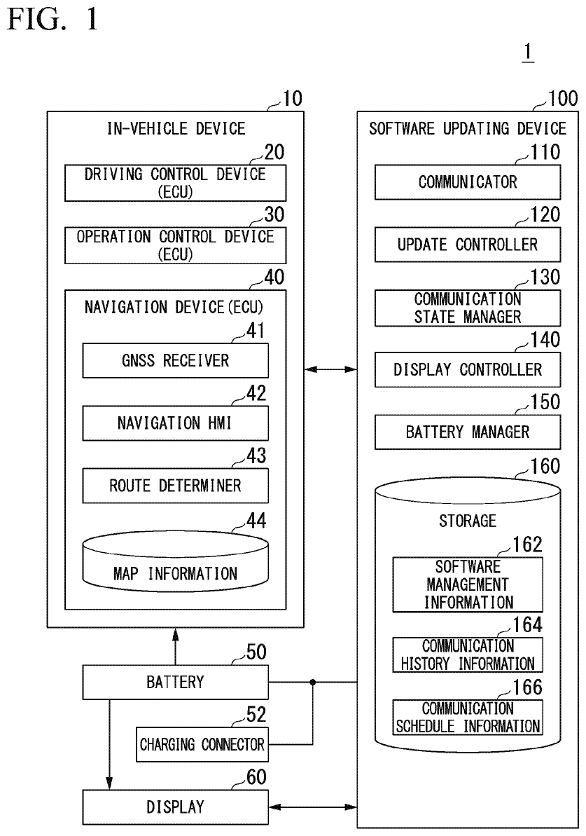

FIG. 1 is a configuration diagram of a vehicle system 1 including a software updating device 100 of a first embodiment. The vehicle system 1 includes, for example, an in-vehicle device 10, a battery (an example of a storage battery) 50, a display 60, and the software updating device 100.

The in-vehicle device 10 includes, for example, a driving control device 20, an operation control device 30, and a navigation device 40. The driving control device 20 performs, for example, automated driving (autonomous driving) control, a driving assistance control, and the like of a vehicle (hereinafter referred to as a vehicle M). Automated driving control is, for example, to control one or both of the steering and the speed of the vehicle M without depending on a driving operation of an occupant of the vehicle M. Driving assistance control is, for example, driving control for supporting the driving operation of an occupant, such as an adaptive cruise control system (ACC), a lane keeping assistance system (LKAS), and a collision mitigation brake system (CMBS). The driving control device 20 executes driving control corresponding to a behavior of the vehicle M or a control instruction from an occupant. The navigation device 40 is an example of a “route guide.”

The operation control device 30 is a device for causing the vehicle M to travel by applying a driving power to the vehicle M. The operation control device 30 includes, for example, a travel driving power output device which outputs a travel driving power (torque) for traveling of the vehicle M to driving wheels, a brake device which outputs a brake torque according to a predetermined braking operation to each vehicle wheel, and a steering device which changes the direction of a steering wheel.

The navigation device 40 includes, for example, a global navigation satellite system (GNSS) receiver 41, a navigation human machine interface (HMI) 42, and a route determiner 43. The navigation device 40 stores map information 44 in a storage device such as a hard disk drive (HDD) or a flash memory. The GNSS receiver 41 identifies the position of the vehicle M on the basis of signals received from a GNSS satellite. The position of the vehicle M may be identified or complemented by an inertial navigation system (INS) using the output of a vehicle sensor (not shown) mounted in the vehicle M. In the first embodiment, a global positioning system (GPS) device instead of the navigation device 40 may be mounted in the vehicle M and the position of the vehicle M may be acquired using the GPS device. The navigation device 40 or the GPS device is an example of a “position acquirer” which acquires the position of the vehicle M.

The navigation HMI 42 includes a display, a speaker, a touch panel, keys, etc. The navigation HMI 42 allows an occupant to set a destination and the like using images, audio, and the like or performs guidance for a travel route to a destination to the occupant. The route determiner 43 determines a route (hereinafter, a route on a map) to a destination input by an occupant using the navigation HMI 42 from the position of the vehicle M identified by the GNSS receiver 41 (or any input position) with reference to the map information 44, for example. The map information 44 is information representing road shapes according to links indicating roads and nodes connected by links, for example. The map information 44 may include curvatures, point of interest (POI) information, and the like of roads. The map information 44 may include, for example, information on the centers of lanes, information on the boundaries of lanes, information on lane types, and the like. The map information 44 may include road information, traffic regulations information, address information (addresses and zip codes), facility information, telephone number information, and the like. The map information 44 may be updated at any time through a communicator 110 communicating with other devices. The navigation device 40 performs route guidance according to map image display through the display 60 or audio output through a speaker (not shown) on the basis of a route on a map.

Here, each of apparatuses of the driving control device 20, the operation control device 30, and the navigation device 40 of the in-vehicle device 10 is configured on the basis of an electronic control unit (ECU). The ECU is an example of a “apparatus controller.” The ECU is realized by connecting a processor, a memory, an auxiliary storage device, an external communication interface, and the like through a bus, for example. Software is installed in the ECU and control of at least a part of an apparatus corresponding to the ECU is performed by executing the software. The software includes at least one program module. A program module includes, for example, one or more programs and executes parts of functions that can be realized by software.

Software can be updated in units of modules according to control of an update controller 120, for example. There are cases below in which a series of processes for downloading software for update (hereinafter referred to as update software) from an external device (e.g., a software providing device) and updating software of an apparatus is referred to as “reprogramming ” When ECUs of apparatuses are not distinguished, the ECUs may be simply referred to as an “ECU” in description.

The battery 50 supplies power to, for example, the in-vehicle device 10, the display 60, the software updating device 100, other electrical apparatuses in the vehicle M, and the like. Power used during execution of reprogramming is chiefly supplied from the battery 50 to an ECU that is an update target. The vehicle system 1 may include a charging connector 52. The charging connector 52 is a detachable connector connected to a charging plug of a charging facility in order to acquire power supplied from a charging location or a charging facility provided in a house of an occupant. For example, charging of the battery 50 is performed in a state in which the charging connector 52 is connected to a charging plug. The vehicle M may include a power receiver (not shown) which wirelessly receives power instead of the charging connector 52. In this case, the battery 50 is wirelessly charged by stopping the vehicle M at a position at which the power receiver can receive power in a noncontact manner from a power transmitter provided in a charging location or the like. The display 60 is, for example, a display device such as a liquid crystal display

(LCD) or an organic electroluminescence (EL) display. The display 60 displays, for example, images generated by a display controller 140. The display 60 may include, for example, a function of receiving details of operations from an occupant as a touch panel device. The display 60 may be integrated with the navigation device 40 to display route guidance to a destination, and the like according to the navigation device 40.

The software updating device 100 includes, for example, the communicator 110, the update controller 120, a communication state manager 130, the display controller 140, a battery manager 150, and a storage 160. These components are realized by, for example, a hardware processor such as a central processing unit (CPU) executing a program (software). Some or all of these components may be realized by hardware (a circuit including a circuitry) such as a large scale integration (LSI) circuit, an application specific integrated circuit (ASIC), a field-programmable gate array (FPGA), or a graphics processing unit (GPU) or realized by software and hardware in cooperation. The program may be stored in advance in the storage 160 or stored in a detachable storage medium such as a DVD or a CD-ROM and installed in the storage 160 by setting the storage medium in a drive device.

The storage 160 is realized by, for example, a hard disk drive (HDD), a flash memory, an electrically erasable programmable read only memory (EEPROM), a read only memory (ROM), a random access memory (RAM), or the like. The storage 160 stores, for example, software management information 162, communication history information 164, communication schedule information 166, a program read and executed by a processor, other various types of information, and the like.

The communicator 110 communicates with various server devices or portable terminal devices or communicates with neighboring vehicles (other vehicles) around the vehicle M using a cellular network, a Wi-Fi network, Bluetooth (registered trademark), dedicated short range communication (DSRC), and the like, for example. Various server devices include, for example, a server device that provides software to be installed in an ECU. The communicator 110 may be a telematics control unit (TCU), for example.

When information representing update of software (hereinafter, update information) is received from an external device through the communicator 110, for example, the update controller 120 notifies an occupant, an owner or the like of the vehicle M of update of the software using the display 60 or the like. The software is software installed in the aforementioned ECU. Further, the update controller 120 performs reprogramming control for updating software installed in each ECU when a software update instruction is received from the occupant, owner or the like of the vehicle M.

For example, the update controller 120 determines whether update is required on the basis of update information from an external device received through the communicator 110 and the software management information 162 stored in the storage 160 and performs reprogramming control when it is determined that update is required. In addition, the update controller 120 adjusts an update timing and the amount of data when update software is downloaded from a server device on the basis of the communication history information 164 stored in the storage 160. Functions of the update controller 120 will be described in detail later.

When the vehicle M has transmitted/received data to/from an external device through the communicator 110, the communication state manager 130 acquires communication states such as the position, a communication method, and the amount of data of the vehicle M at that time. The communication state manager 130 generates the communication history information 164 as an example of past communication states on the basis of the acquired communication states and causes the storage 160 to store the generated communication history information 164.

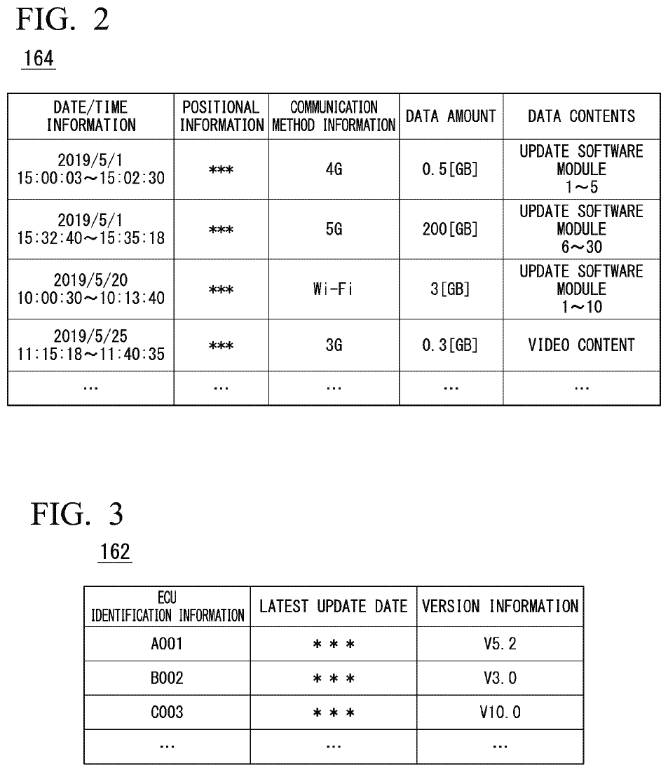

FIG. 2 is a diagram showing an example of details of the communication history information 164. In the communication history information 164, positional information, communication method information, data amount, data contents, and the like are associated with date/time information. The date/time information is information about dates and times at which communication with the outside has been performed through the communicator 110. The date/time information includes, for example, information on a communication start time and a communication end time. The date/time information is acquired, for example, using a clock (not shown) mounted in the vehicle M. The positional information is, for example, the position of the vehicle M when communication with the outside has been performed through the communicator 110. The positional information may include, for example, information from a communication start point to a communication end point (section or route information). The positional information is acquired by the navigation device 40, for example. The communication method information is, for example, information about a communication method when the communicator 110 has performed communication with the outside. The communication method information includes, for example, standard information representing the generation of a communication method in radio wave communication. The standard information includes, for example, the third generation mobile communication standard (hereinafter referred to as “3G”), the 3.9 generation mobile communication standard (hereinafter referred to as “LTE”), the fourth generation mobile communication standard (hereinafter referred to as “4G”), and the fifth generation mobile communication standard (hereinafter referred to as “5G”). These communication standards allow higher speed communication with successive generation.

Accordingly, the communication method information corresponds to information about a communication speed level. The aforementioned communication standards are used for communication with carriers (common carriers). The communication method information may include information about standards of wireless local area networks (LANs) such as Wi-Fi. Wi-Fi is a radio wave communication standard in which each individual, each enterprise or the like can freely use a network thereof. Communication standards in communication methods conforming to Wi-Fi have significantly narrow radio wave arrival ranges and are limited to use over about 10 [m] from an antenna position of Wi-Fi. In the case of a communication method conforming to Wi-Fi, information about a frequency band (e.g., 5 [GHz] or 2.4 [GHz]) and information about a communication standard in the frequency band may be included in the communication method information. The communication method information may include identification information for identifying a facility of a communication destination (wireless router, a base station, or the like).

The communication method information may include information about communication states. A communication state includes, for example, information based on a radio field intensity and information representing whether communication has stabilized. A radio field intensity is measured by the communicator 110, for example. The communication state manager 130 determines that communication has stabilized, for example, when a variation in a radio field intensity measured by the communicator 110 for a predetermined time is less than a threshold value and determines that communication has not stabilized when the variation exceeds the threshold value. The data amount is a data amount on which the communicator 110 has performed communication in a period from a communication start time to a communication end time, for example. Although the data amount is a data amount received from the outside, the data amount may include a data amount transmitted to the outside in addition thereto. The data contents are information about data contents acquired from the outside by the communicator 110. The data contents are, for example, identification information for identifying update software (e.g., module type or version information). The data contents may include other types of content data such as video content, music content, and map data downloaded from the outside through wireless communication.

The communication state manager 130 generates the communication history information 164 or updates it to latest information whenever communication with the outside is performed. When the vehicle M is already traveling at a position different from that of positional information included in the communication history information 164, the communication state manager 130 may learn a communication state of the different position on the basis of the position of the vehicle M and reflect a learning result in the communication history information 164. Accordingly, it is possible to reduce a processing load.

The display controller 140 controls the display 60 and generates images including information about update of software of an ECU and information about driving control and driving assistance, and the like. The generated images may include a graphical user interface (GUI) such as icons. The display controller 140 causes the display 60 to display the generated images, route images acquired from the navigation device 40, content data downloaded from an external device, information about the communication schedule information which will be described later, and the like.

The battery manager 150 manages battery states such as a remaining amount of energy and charging/discharging of the battery 50. For example, the battery manager 150 measures a terminal voltage of the battery 50 and acquires a remaining amount of energy on the basis of the level of the measured terminal voltage. The battery manager 150 may acquire a remaining amount of energy, for example, by totaling the amount of current accumulated during charging using a current detection register and obtaining the amount of current output during discharging. For example, the battery manager 150 may store a database of discharging characteristics, temperature characteristics and the like of the battery 50 in advance in the storage 160 and the like and acquire a remaining amount of energy on the basis of a measured voltage value and current value, and the database. The battery manager 150 may employ a combination of some or all of the above-described acquisition methods. The battery manager 150 may acquire a state of charge (SOC) instead of the aforementioned remaining amount of energy.

### [Update Controller]

Next, the functions of the update controller 120 will be described in detail. The update controller 120 communicates with an external device (hereinafter described as a server device) through wireless communication such as over the air (OTA), for example, and performs reprogramming of software installed in an ECU of a target apparatus. Specifically, the update controller 120 acquires version information of software installed in an ECU of each apparatus of the in-vehicle device 10 from the software management information 162 stored in the storage 160.

FIG. 3 is a diagram showing an example of details of the software management information 162. In the software management information 162, a latest update date and version information are associated with ECU identification information. The ECU identification information is identification information for identifying ECUs of apparatuses of the in-vehicle device 10. The latest update date is a latest update date and time of reprogrammed software. The version information is information about the version of software downloaded from the server device and installed in an ECU.

The update controller 120 communicates with the server device through the communicator 110 at a predetermined timing and inquires about version information of each piece of software in order to determine whether software update is required. Then, the update controller 120 compares the version information acquired from the server device with version information acquired from the software management information 162 and updates target software when they are not consistent with each other (more specifically, when the version from the server device is new).

The update controller 120 may cause the display controller 140 to generate an image for inquiring of an occupant about whether software update will be executed and cause the display 60 to display the generated image before software update is started. The update controller 120 does not perform software update when selection of denial of execution of update is received through the display 60. The update controller 120 controls a software update timing in association with route guidance to a destination according to the navigation device 40 when selection of permission of execution of update is received through the display 60.

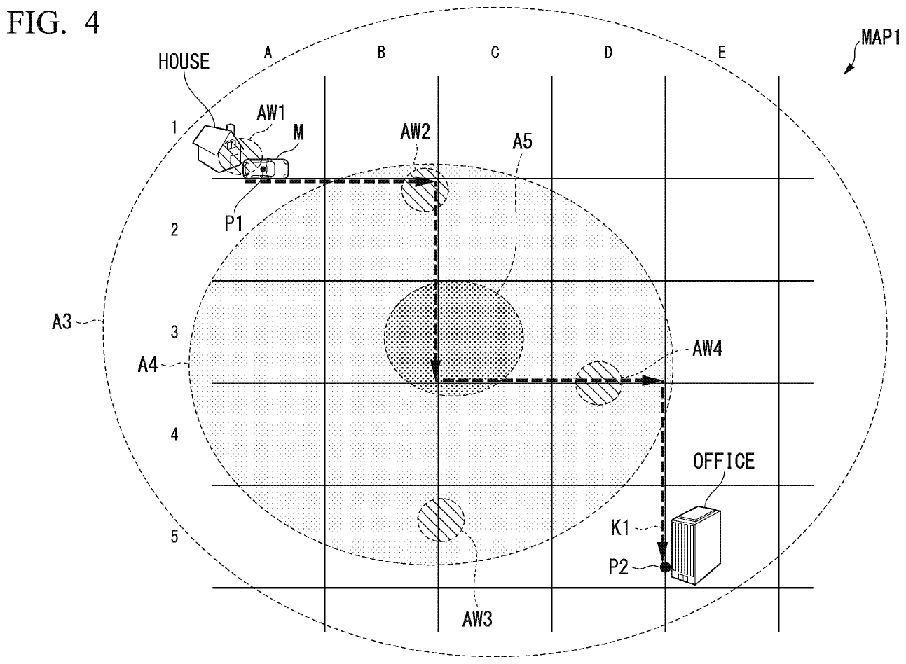

FIG. 4 is a diagram for describing processing of the update controller 120. In the example of FIG. 4, a part of the map information 44 is displayed. A map image MAP1 shown in FIG. 4 is divided into blocks 1 to 5 in the vertical direction and blocks A to E in the horizontal direction such that positions and areas can be identified. Each block may be defined on the basis of roads and intersections or in units of distance according to map coordinates, for example. In the following description, it is assumed that roads and intersections are present at the borders of blocks.

The navigation device 40 determines a route from the current position of the vehicle M to a destination, for example, when input of the destination is received through the navigation HMI 42. In the example of FIG. 4, a route K1 from a point (current place) P1 at which the vehicle M parked at a house HO is present to a point P2 at which an office OF (destination) is present is determined. Then, the update controller 120 acquires past communication states on the route K1 with reference to the communication history information 164 using positional information on the determined route K1 and reflects the acquired communication states in the map image MAP1. The example of FIG. 4 shows that communication method information is overlaid on the map image MAP1 on the basis of the communication history information 164. FIG. 4 shows an area in which communication has been performed with the communication standard of 5G (hereinafter referred to as “5G area”, the same applies to other standards) A5, a 4G area A4, a 3G area A3, and Wi-Fi areas AW1 to AW4. In the example of FIG. 4, the route K1 includes the Wi-Fi areas AW1, AW2, AW4, and the 5G area A5 in which communication can be performed at a higher speed than in 3G and 4G. Accordingly, the update controller 120 curbs download of update software in the 3G area A3 and the 4G area A4 in which communication is performed at a lower speed (a communication speed is less than a predetermined speed) than in the Wi-Fi areas and the 5G area and controls an update timing such that the update software is downloaded when the vehicle M is traveling in areas (the Wi-Fi areas AW1, AW2 and AW4, and the 5G area A5) in which communication has been performed in a communication state of high-speed communication (a communication speed is equal to or higher than the predetermined speed).

Here, the Wi-Fi area AW1 is assumed to be an area (a private Wi-Fi area) in which communication is performed through a Wi-Fi router installed in the house HO and contracted by an occupant at a monthly flat rate. The Wi-Fi areas AW2 and AW4 area assumed to be areas (free Wi-Fi areas) provided by enterprises, shops, and the like in which anyone can use Wi-Fi without authentication or with simple authentication and user costs are not incurred. The 5G area A5 is assumed to be an area provided by a communication carrier to a plurality of persons who have performed user authentication, in which a fee is added for each data amount according to contents of a contract or an upper limit of data amounts for which high-speed communication can be performed is restricted.

When there is a plurality of areas in which high-speed communication can be performed, the update controller 120 may adjust update software download timing on the basis of priority set for each area. The priority is set, for example, on the basis of a communication speed (maximum speed), a communication cost, a type of standard, the size of a communication available area, a degree of security, a distance from a current position, and the like. For example, the 5G area A5 has a wider communication available area than those of the Wi-Fi areas AW1, AW2 and AW4. The Wi-Fi area AW1 has higher security than those of the Wi-Fi areas AW2 and SW4 and the 5G area 5A. If the 5G area A5 is for communication using a cellular network, a communication cost is generated for one packet and thus the cost is likely to increase when software update for a large amount of data or a plurality of vehicles is performed. Accordingly, the update controller 120 may set a high priority for a communication method conforming to Wi-Fi when there is a plurality of communication methods that allow high-speed communication.

Furthermore, when communication is performed using a communication method conforming to Wi-Fi at a specific point such as the house HO or an office and the vehicle M stops, for example, the update controller 120 may adjust a schedule such that software is updated in preference to other communication methods. When transmission and reception of data are performed, a security strength is maximized most efficiently in the case of communication using private Wi-Fi in a state in which the vehicle M is parked at the house HO. Accordingly, when communication is available in a private Wi-Fi area, the update controller 120 sets a high priority such that communication is actively performed in that area.

Therefore, in the example of FIG. 4, the update controller 120 sets priorities for “Wi-Fi area AW1,” “Wi-Fi areas AW2 and AW4,” and “5G area 5A” in ascending order and allocates data amounts of update software to be downloaded in the set order of priority.

When data of update software is divided into modules or the like and downloaded, the update controller 120 may set an area in which download will be performed and a degree of data amounts to be downloaded. The update controller 120 causes the storage 160 to store a schedule of allocated download as the communication schedule information 166.

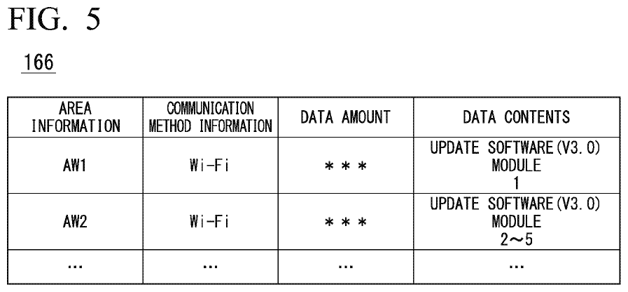

FIG. 5 is a diagram showing an example of details of the communication schedule information 166. In the communication schedule information 166, for example, communication method information, data amount, and data contents are associated with area information. The area information is, for example, information about an area in which data will be downloaded. The data contents include, for example, version information (e.g., V3.0), module information, and the like of update software to be downloaded. For example, when program modules included in update software to be reprogrammed are modules 1 to 5, the update controller 120 sets an area, a data amount, and data contents for download in units of one or a plurality of modules.

The vehicle M is traveling to a destination except in the case in which the vehicle M has stopped due to a red light, a traffic jam, or the like. Accordingly, a time for which the vehicle M is present within a communication available area is limited. Therefore, the update controller 120 may estimate a time for which the vehicle M is present within a communication available range on the basis of date/time information stored in the communication history information 164 or regulation speeds of roads on the route acquired with reference to the map information 44. Then, the update controller 120 estimates a data amount that can be acquired when the vehicle M passes through the area and sets data contents to be downloaded corresponding to the estimated data amount on the basis of the estimated time and a communication speed in the area. In the example of FIG. 5, a communication schedule is set such that module 1 of update software (version 3.0) will be downloaded in the Wi-Fi area AW1 and modules 2 to 5 of the update software (version 3.0) will be downloaded in the Wi-Fi area AW2. The update controller 120 downloads the update software on the basis of the set communication schedule information 166 and performs update processing after downloading.

When the vehicle M has passed through the area without downloading data as scheduled due to communication failure caused by communication congestion or communication strength deterioration, the update controller 120 may regenerate update schedule information, for example, using high-speed communication available areas (the Wi-Fi area AW4 and the 5G area 5A) which are not included in the communication schedule. When the update controller 120 initially generates communication schedule information, the update controller 120 may anticipate regeneration and generate the communication schedule information in advance while saving reserve high-speed communication areas. The update controller 120 may generate communication schedule information including not only the route from the point P1 to the point P2 but also a return route from the point P2 to the point P1.

When the update software is software with high urgency, the update controller 120 may download the update software using a communication method by which communication can be performed at the present point in time irrespective of high-speed communication and low-speed communication. Software with high urgency is, for example, software that significantly affects the behavior of the vehicle M such as driving control and operation control. Accordingly, since update software with respect to the navigation device 40, for example, is not software with high urgency, data download and update processing are executed on the basis of the above-described update schedule information. Software with high urgency may be software for which the fact that it is software with high urgency has been notified through externally received update information.

When the data amount of the update software is within a threshold value, the update controller 120 may download the update software according to communication that can be performed at the present point in time. In the case of a small amount of data, downloading can be performed within a short time even in low-speed communication, and thus appropriate reprogramming can be realized since communication is rarely suspended or communication states rarely switch.

The update controller 120 updates the communication history information 164 on the basis of a communication state at the time of data download. Accordingly, it is possible to acquire communication states in real time and ascertain change in communication states more accurately.

The update controller 120 may set an update timing on the basis of a remaining amount of energy and charging/discharging states of the battery 50 managed by the battery manager 150. For example, the update controller 120 executes software reprogramming when the remaining amount of energy is equal to or greater than a predetermined amount and performs control such that reprogramming is curbed when the remaining amount of energy is less than the predetermined amount. The update controller 120 may perform control such that software reprogramming is executed, for example, in a state in which the charging connector 52 of the vehicle that stops at a house is connected to a charging facility (charging state) and high-speed communication is available. Accordingly, it is possible to curb exhaustion of power of the battery 50 during reprogramming and suspension of reprogramming Therefore, it is possible to improve stability in reprogramming

When reprogramming according to the update software has ended normally, the update controller 120 updates the software management information 162 stored in the storage 160. When reprogramming according to the update software has not ended normally, the update controller 120 may re-execute reprogramming at a predetermined timing.

Although the update controller 120 controls an update software download timing using the communication history information 164 on the basis of a route to a destination set by the navigation device 40 in the above-described example, a navigation route may be changed on the basis of communication states of the communication history information 164 instead thereof (or in addition thereto). In this case, when a route set by the navigation device 40 does not include a 5G area or a Wi-Fi area in which high-speed communication is available, the update controller 120 determines whether an area in which high-speed communication is available is present near the route using the communication history information 164. An area near a route is, for example, an area in which the shortest distance from the route is within a predetermined distance and communication cannot be performed from the route. When a high-speed communication available area is present near the route, the update controller 120 generates a new route that passes through the high-speed communication area and outputs the generated route to the navigation device 40 along with a route change instruction. The navigation device 40 sets the newly generated route as a route to be shown to an occupant on the basis of the route change instruction. Then, the update controller 120 generates the communication schedule information 166 on the basis of the changed route and downloads the update software on the basis of the generated communication schedule information 166.

### [Processing Flow]

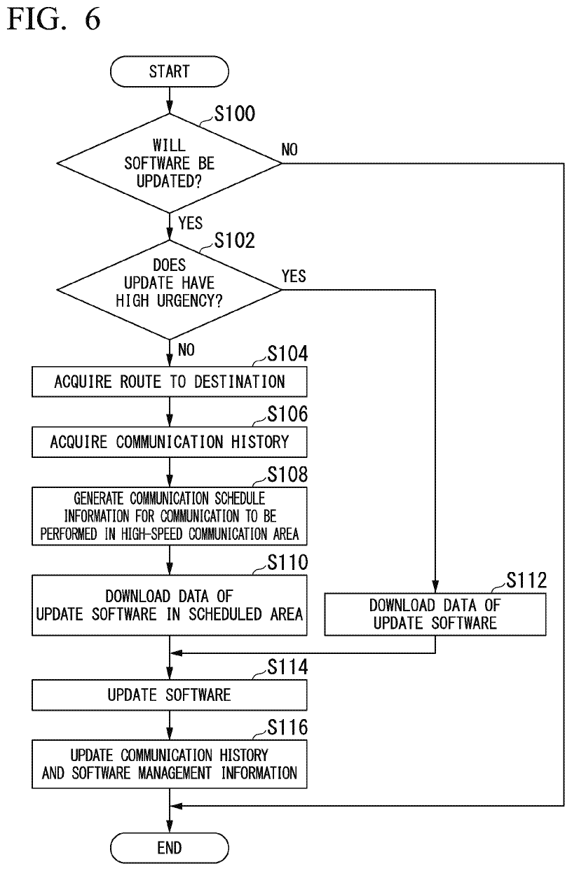

FIG. 6 is a flowchart showing an example of processing of the software updating device 100 of the first embodiment. First, the update controller 120 determines whether to update software on the basis of version information of update software information transmitted from a server device or the like and version information of the software management information 162 (step S100). When it is determined that the software will be updated, the update controller 120 determines whether the update has high urgency (step S102). When it is determined that the update is not update with high urgency, the update controller 120 acquires a route to a destination of the vehicle M from the navigation device 40 (step S104) and acquires a communication history on roads corresponding to the route with reference to the communication history information 164 stored in the storage 160 on the basis of the acquired route (step S106).

Subsequently, the update controller 120 generates communication schedule information 166 for communication to be performed in a high-speed communication area on the basis of the communication history (step S108). Then, the update controller 120 downloads data of update software in the scheduled area on the basis of the generated communication schedule information 166 (step S110). When it is determined that the update has high urgency in the process of step S102, the update controller 120 downloads the data of the update software in a communication state in which communication is available at the current position (step S112). After the process of step S110 or step S112 ends, the update controller 120 updates the software (step S114). Subsequently, the update controller 120 updates the communication history information 164 and the software management information 162 (step S116). Accordingly, processing of this flowchart ends. When it is determined that the software will not be updated in the process of step S100, processing of this flowchart ends.

According to the software updating device of the above-described first embodiment, it is possible to download data using high-speed communication on the basis of a past communication history of the vehicle (host vehicle) M. Accordingly, it is possible to update software more rapidly.

### Second Embodiment

Next, a software updating device 100A of a second embodiment will be described. The second embodiment differs from the first embodiment in that an action of the vehicle M is predicted on the basis of the communication history information 164 and a timing is controlled on the basis of a prediction result. Accordingly, description below will focus on the aforementioned difference. Hereinafter, the same functions as those of the first embodiment are denoted by the same names and symbols and specific description thereof is omitted. The same applies to subsequent embodiments.

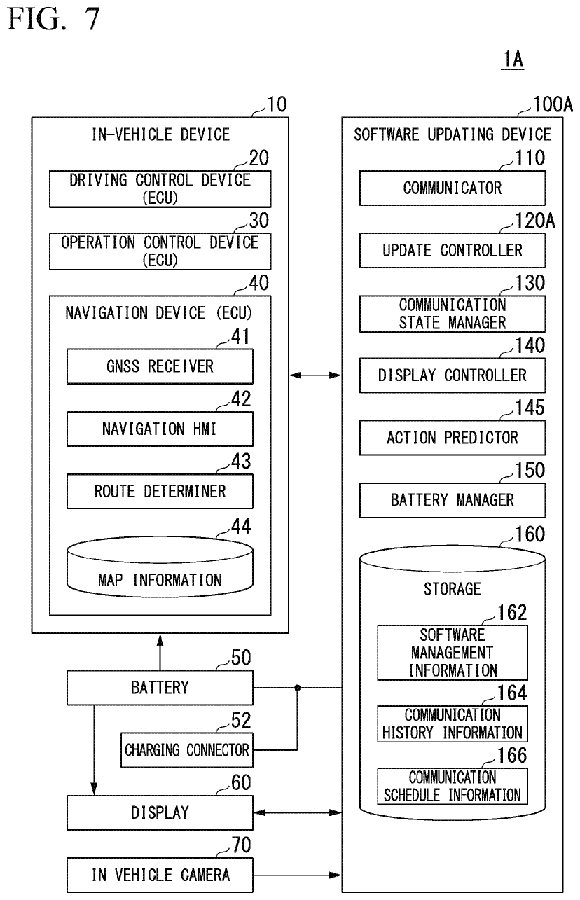

FIG. 7 is a configuration diagram of a vehicle system 1A including a software updating device 100A of the second embodiment. The vehicle system 1A includes, for example, an in-vehicle device 10, a battery (an example of a storage battery) 50, a display 60, an in-vehicle camera 70, and the software updating device 100A. The vehicle system 1A differs from the vehicle system 1 of the first embodiment in that the in-vehicle camera 70 is provided and the software updating device 100 is replaced with the software updating device 100A.

The in-vehicle camera 70 is, for example, a digital camera using a solid-state imaging element such as a charge coupled device (CCD) or a complementary metal oxide semiconductor (CMOS). The in-vehicle camera 70 may be a stereo camera. The in-vehicle camera 70 is attached to any place inside the vehicle M. The in-vehicle camera 70 images a region including the face, the upper body, a hand, an arm, and the like of an occupant present in the vehicle cabin. The in-vehicle camera 70 may image the aforementioned region periodically repeatedly or at a predetermined timing. An image captured by the in-vehicle camera 70 is output to the software updating device 100A.

The software updating device 100A includes, for example, a communicator 110, an update controller 120A, a communication state manager 130, a display controller 140, an action predictor 145, a battery manager 150, and a storage 160. These components are realized by a hardware processor such as a CPU executing a program (software). Some or all of these components may be realized by hardware (a circuit including a circuitry) such as an LSI circuit, an ASIC, an FPGA or a GPU or realized by software and hardware in cooperation. The program may be stored in advance in the storage 160 or stored in a detachable storage medium such as a DVD or a CD-ROM and installed in the storage 160 by setting the storage medium in a drive device. The software updating device 100A differs from the software updating device 100 of the first embodiment in that the action predictor 145 is included and the update controller 120 is replaced with the update controller 120A.

The update controller 120A receives update information and version information from an external device, compares the received version information with version information acquired from the software management information 162, and updates target software when the two pieces of version information are not consistent with each other. In this case, the update controller 120A causes the action predictor 145 to perform prediction of a future action of the vehicle M. The update controller 120A may cause the action predictor 145 to perform action prediction when the vehicle M is traveling in a state in which a destination is not set by the navigation device 40 or when other conditions are satisfied.

The action predictor 145 performs prediction of a future action of the vehicle M on the basis of the communication history information 164 when a software update notification or an action prediction instruction is received from the update controller 120A. For example, the action predictor 145 acquires a current travel state of the vehicle M on the basis of positional information of the vehicle M, variation in the positional information in a predetermined time, a vehicle speed, or a traveling direction. The action predictor 145 acquires communication method information, a data amount, data contents, and the like associated with positional information approximate to the position of the vehicle M with reference to the communication history information 164 on the basis of the position of the vehicle M. The action predictor 145 performs action prediction from the current position of the vehicle M on the basis of positional information and date/time information of the communication history information 164.

The action predictor 145 may perform collation with the communication history information 164 using the current position of the vehicle M and date/time information. Accordingly, it is possible to perform action prediction with higher accuracy when there are actions habituated in days of the week and time periods.

The action predictor 145 may estimate a state of an occupant (e.g., a driver) from an image captured by the in-vehicle camera 70 and perform prediction of an action of the vehicle M on the basis of the estimated state. For example, the state of the occupant includes some or all of drowsiness, the direction of the line of sight, emotion, and the like. The action predictor 145 acquires face feature information such as the position of the face, the positions, disposition and color information of the eyes, nose and mouth of the occupant by analyzing an image captured by the in-vehicle camera 70 and acquires presence or absence of drowsiness, the line of sight and emotion of the occupant on the basis of the acquired feature information and model information which is not shown. The model information is information generated by performing machine learning such as deep learning on learning target information using artificial intelligence (AI) or the like. The learning target information is information in which an image of a person is associated with a type of emotion corresponding to the image. When an image or face feature information is input, the model information outputs an emotion with respect to an occupant or feature information included in the image. An emotion is, for example, a feeling. The action predictor 145 may store feature information associated with a plurality of emotions of an occupant in the storage 160 in advance and acquire a state of the occupant by comparing feature information acquired from the image with the stored feature information. The action predictor 145 may acquire voice of the occupant through a microphone (not shown) mounted in the vehicle M and acquire a state (e.g., an emotion) of the occupant on the basis of the acquired voice instead of the above-described image analysis (or in addition thereto).

In addition, the action predictor 145 performs prediction of a future action of the vehicle M on the basis of the travel state of the vehicle M, the state of the occupant, and the communication history information 164. For example, when there are two routes predicted from the current travel state of the vehicle M and it is assumed that the occupant is drowsy (eyelids come down) or the occupant is angry, the action predictor 145 determines that the vehicle M is highly likely to be parked soon and performs action prediction having a route having a shorter distance (route having a shorter distance to an estimated destination) between the two predicted routes as a predicted route. When it is assumed that the occupant is not drowsy or is smiling, the action predictor 145 determines that the occupant is highly likely to continue driving and performs action prediction having a route having a longer distance (route having a longer distance to an estimated destination) between the two predicted routes as a predicted route. Accordingly, the action predictor 145 can perform action prediction with higher accuracy.

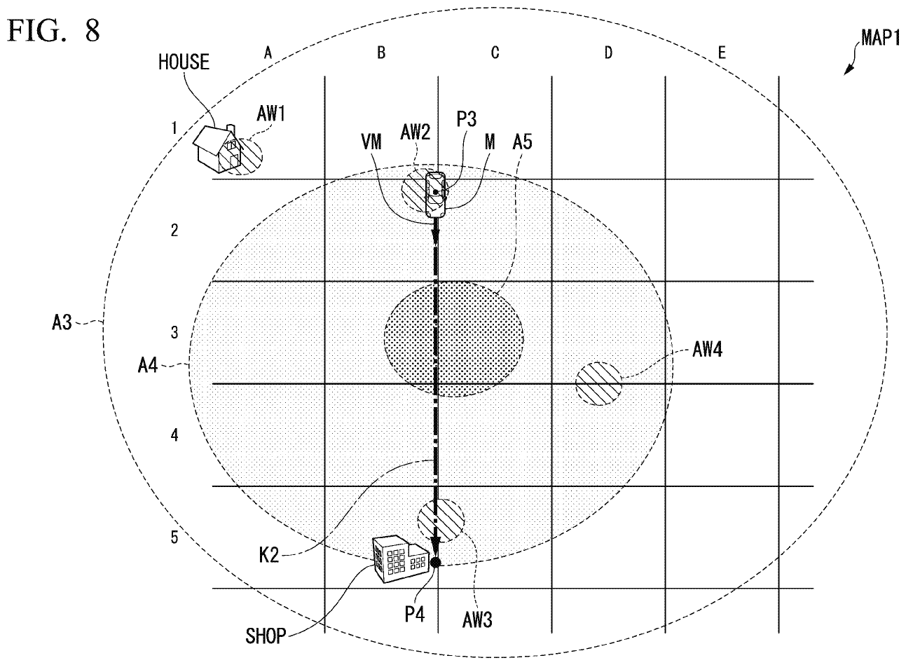

The update controller 120A generates communication schedule information 166 on the basis of an action of the vehicle M predicted by the action predictor 145. FIG. 8 is a diagram for describing processing of the update controller 120A. In the example of FIG. 8, communication method information is overlaid on the same map image MAP1 as that of FIG. 4. In FIG. 8, it is assumed that the vehicle M is present at a current point

P3 and is traveling in a downward direction of the map image MAP1 shown in FIG. 8 at a speed VM. In this case, the action predictor 145 predicts that the vehicle M is headed for a shop SH from a past action history with reference to the communication history information 164 and generates a predicted route K2. The update controller 120 refers to the communication history information 164 on the basis of the predicted route K2 from the action predictor 145 and generates communication schedule information 166 for communication to be performed in a high-speed communication area on the basis of priority of communication methods, and the like. In the example of FIG. 8, communication schedule information in which the Wi-Fi areas AW2 and AW3 are prioritized is generated.

### [Processing Flow]

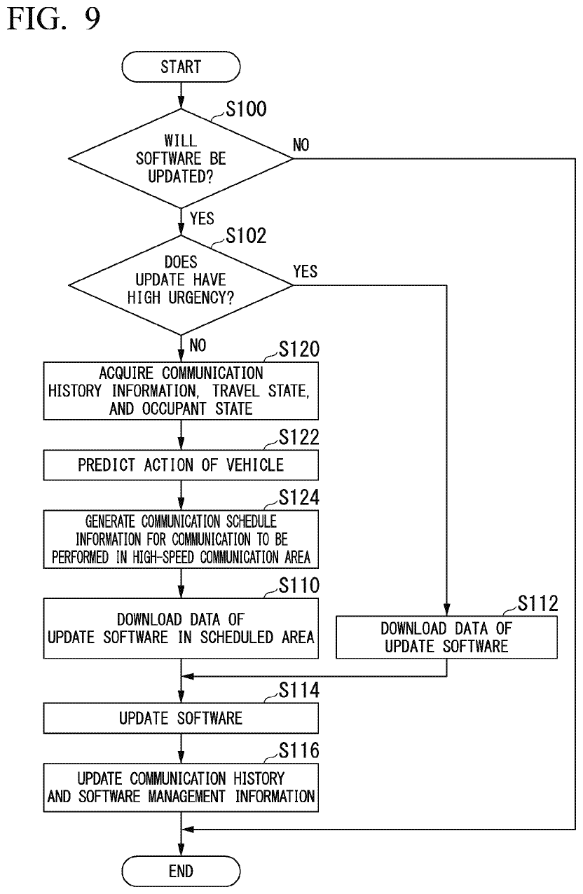

FIG. 9 is a flowchart showing an example of processing of the software updating device 100A of the second embodiment. Processing shown in FIG. 9 differs from processing of the software updating device 100 of the above-described first embodiment in that processes of steps S120 to S124 are added instead of the processes of steps S104 to S108. Accordingly, description below will chiefly focus on the processes of steps S120 to S124.

When the update is not update with high urgency in the process of step S104 shown in FIG. 9, the action predictor 145 acquires the communication history information 164, a travel state of the vehicle M, and an occupant state (step S120).

Subsequently, the action predictor 145 predicts an action of the vehicle and generates a predicted route (step S122). Then, the update controller 120 generates communication schedule information 166 for communication to be performed in a high-speed communication area on the basis of the predicted route and the communication history information 164 (step S124) and performs processes of step S110 and subsequent processes.

According to the software updating device of the above-described second embodiment, it is possible to download update software at an appropriate timing in association with route guidance of the navigation device 40 by changing a route to a destination to routes on which high-speed communication is available on the basis of a communication history.

In the second embodiment, it is possible to generate more appropriate communication schedule information on the basis of a predicted route and the like even when a route to a destination has not been set by the navigation device 40 in addition to obtaining the same effects as those of the first embodiment. According to the second embodiment, it is possible to generate an update schedule in association with habits (e.g., commuting and shopping) of an occupant.

### Third Embodiment

Next, a software updating device 100 of a third embodiment will be described. The third embodiment differs from the first embodiment in that information about communication states (communication history information and communication state maps of other vehicles which will be described later) is acquired from other vehicles or an external device and an update software data download timing is controlled on the basis of the acquired information. Accordingly, description below will chiefly focus on the aforementioned difference and description of other parts will be omitted. In the third embodiment, it is assumed that the same software updating device 100 as that of the first embodiment is also mounted in other vehicles.

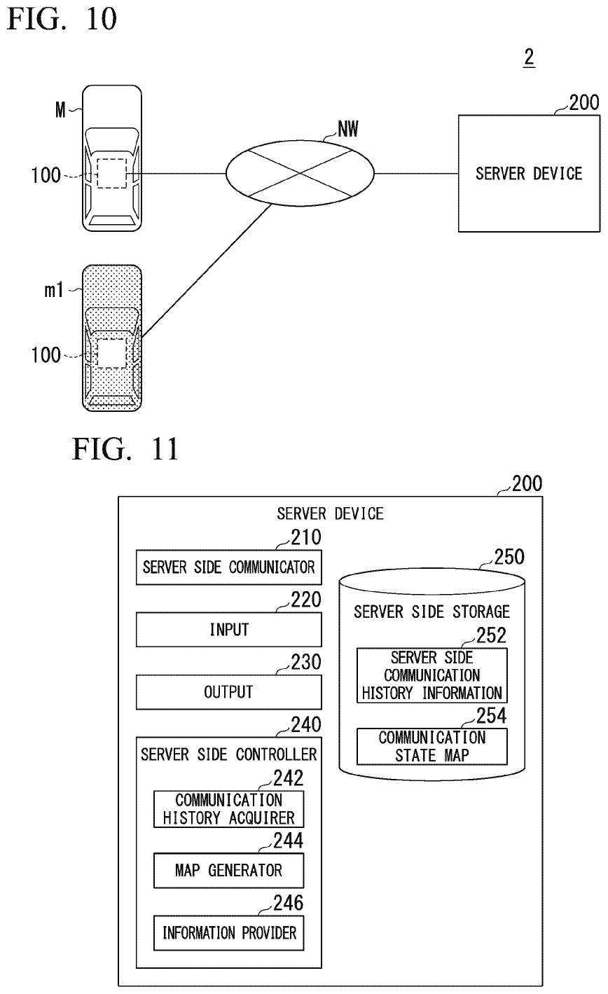

FIG. 10 is a diagram showing an example of a configuration of a software updating system 2 including the software updating device 100 according to the third embodiment. The software updating system 2 includes, for example, the software updating device 100 mounted in each of one or more vehicles and a server device 200. Hereinafter, description will be given using the vehicle (host vehicle) M and another vehicle ml for convenience of description.

The software updating device 100 and the server device 200 can communicate with other via a network NW. The network NW includes, for example, a cellular network, a Wi-Fi network, Bluetooth (registered trademark), the Internet, a wide area network (WAN), a LAN, a public line, a provider device, a dedicated line, a wireless base station, etc. These components may directly perform wireless communication without using the network NW. In addition, in the software updating system 2 shown in FIG. 10, the vehicle M and the other vehicle ml may perform vehicle-to-vehicle communication with each other when a distance therebetween is within a predetermined distance. In the third embodiment, the software updating device 100 may be the software updating device 100A of the second embodiment.

FIG. 11 is a configuration diagram of the server device 200 of the third embodiment. The server device 200 includes, for example, a server side communicator 210, an input 220, an output 230, a server side controller 240, and a server side storage 250. The server device 200 may serve as, for example, a cloud server which communicates with the software updating device 100 via a network NW and transmits and receives various types of data.

The server side communicator 210 includes a communication interface such as an NIC. The server side communicator 210 communicates with the software updating device 100 mounted in each vehicle via the network NW.

The input 220 is a user interface such as buttons, a keyboard, or a mouse, for example. The input 220 receives an operation of a user (e.g., a manager or the like) and outputs a signal in accordance with the received operation to the server side controller 240. The input 220 may be a touch panel integrated with a display of the output 230.

The output 230 outputs information to the user. The output 230 includes, for example, the display which displays images and an audio output which outputs audio. The display includes, for example, a display device such as a liquid crystal display (LCD) or an organic electroluminescence (EL) display. The display displays an image corresponding to information output from the server side controller 240. The audio output is, for example, a speaker. The audio output outputs audio corresponding to information output from the server side controller 240.

The server side controller 240 includes, for example, a communication history acquirer 242, a map generator 244, and an information provider 246. Each component of the server side controller 240 is realized, for example, by a processor such as a CPU executing a program stored in the server side storage 250. Some or all components of the server side controller 240 may be realized by hardware (a circuit including a circuity) such as an LSI circuit, an ASIC, an FPGA or a GPU or realized by software and hardware in cooperation.

The server side storage 250 is realized, for example, by a storage device such as an HDD, a flash memory, an EEPROM, a ROM or a RAM. The server side storage 250 stores server side communication history information 252, a communication state map 254, a program read and executed by a processor, other various types of information, and the like.

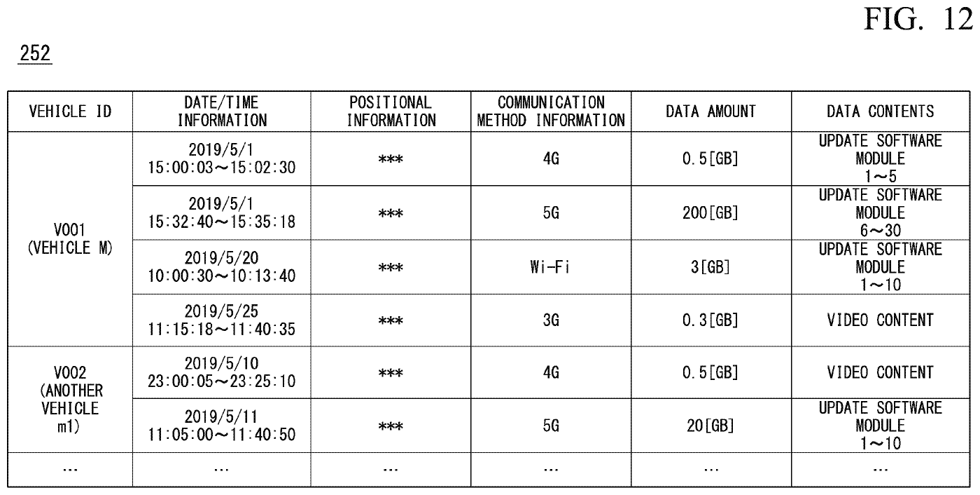

The communication history acquirer 242 acquires communication history information transmitted from one or more vehicles (the vehicle M and the other vehicle ml) via the network NW and causes the server side storage 250 to store the acquired communication history information as the server side communication history information 252. FIG. 12 is a diagram showing an example of details of the server side communication history information 252. In the server side communication history information 252, date/time information, positional information, communication method information, a data amount, and data contents are associated with a vehicle ID as identification information for identifying a vehicle. Accordingly, it is possible to manage communication history information for each vehicle.

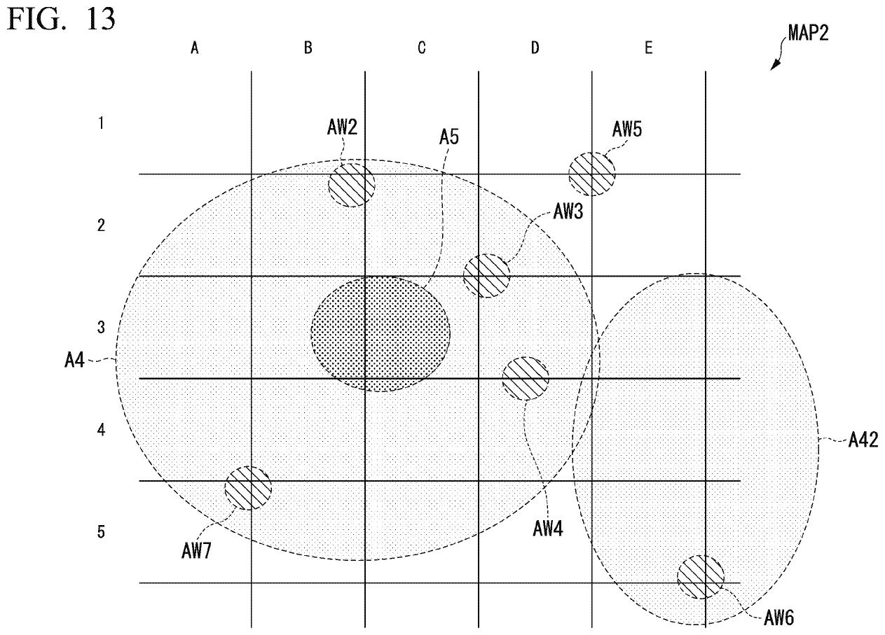

The map generator 244 generates a map representing a communication state on the basis of the server side communication history information 252. FIG. 13 is a diagram showing an example of a map generated by the map generator 244. In the example of FIG. 13, a map image MAP2 composed of the same areas as those of FIG. 4 described above is shown. This map image MAP2 may be acquired from a vehicle or acquired from map information (not shown) stored in the server side storage 250. For example, the map generator 244 associates positional information in the map image MAP2 with positional information of the server side communication history information 252 and plots a communication available area for each communication method on the map image MAP2.

In this case, the map generator 244 may not plot a communication available area of a communication method (e.g., G3) other than high-speed communication on the map image MAP2. Accordingly, it is possible to curb communication other than high-speed communication when communication schedule information is generated on the side of a vehicle using a communication state map.

The map generator 244 may not plot a communication available area (e.g., the Wi-Fi area AW1 shown in FIG. 4) of a communication method (e.g., private Wi-Fi rather than free Wi-Fi) that cannot be used by a third party according to personal contract or the like on the map image MAP2. Accordingly, it is possible to generate a communication state map without including information personally contracted by an occupant of a vehicle. Therefore, it is possible to generate an appropriate communication schedule from information on only communication available areas included in the communication state map. In the example of FIG. 13, a 5G area A5, a 4G area A4, A42, and Wi-Fi areas AW2 to AW7 are shown. The map generator 244 causes the server side storage 250 to store the generated communication state map 254. The map generator 244 can manage communication states in real time by repeating map generation at predetermined intervals or timing.

The information provider 246 transmits, on the basis of a communication state map acquisition request from a vehicle, the communication state map 254 stored in the server side storage 250 to the vehicle that requests the communication state map 254.

When information about a current position and a destination has been transmitted from the vehicle, the information provider 246 may extract a map including the current position and the destination of the vehicle from the communication state map 254 and transmit the extracted map to the vehicle. Accordingly, it is possible to reduce a data amount.

The server device 200 in the third embodiment may include a function of distributing update software in addition to the function of generating and providing a communication state map. In this case, the information provider 246 transmits update information to the software updating device 100 when software is updated for an ECU or the like of a vehicle. When an update instruction is received from an occupant, an owner or the like of a vehicle in response to a notification of the software updating device 100, for example, the information provider 246 transmits information used for update (update software and the like) via the network NW on the basis of a download timing controlled by the software updating device 100.

The information provider 246 may perform machine learning using statistical processing or the like using the server side communication history information 252, predict an action pattern of each vehicle on the basis of a learning result, and generate communication schedule information for update data download for each vehicle on the basis of future action prediction using the predicted action pattern instead of (or in addition to) providing a communication state map. The information provider 246 may estimate an emotion and the like of a driver on the basis of a predicted action pattern and generate communication schedule information on the basis of an estimation result. The software updating device 100 can reduce a processing load for setting a communication schedule by downloading update data using the communication schedule information provided from the information provider 246.

For example, the update controller 120 of the third embodiment transmits a map acquisition request to the server device 200 when communication for updating software is executed and the data amount of the communication history information 164 of the vehicle M is equal to or less than a predetermined amount or when a past communication state (communication history) corresponding to a current position is not present. The update controller 120 acquires a communication state map of a predetermined range including a route of the vehicle M and generates the communication schedule information 166 on the basis of the acquired communication state map. The update controller 120 may transmit a communication history information acquisition request to the other vehicle ml and acquire communication history information managed in the other vehicle ml when vehicle-to-vehicle communication with the other vehicle ml present near the vehicle M is available (when the other vehicle ml is present within a predetermined distance from the vehicle M) instead of acquiring a communication state map from the server device 200.

The update controller 120 may acquire the aforementioned information from one or both of the other vehicle ml and the server device 200. For example, the update controller 120 acquires communication history information from the other vehicle ml when the other vehicle ml is present within a predetermined range from the vehicle M. The update controller 120 acquires a communication state map from the server device 200 when the other vehicle ml is not present or the data amount of communication history information managed in the other vehicle ml is equal to or less than a predetermined amount. The update controller 120 may acquire the aforementioned information from one or both of the other vehicle ml and the server device 200 on the basis of a selection result of an occupant. The update controller 120 may perform control such that communication with the other vehicle ml and the server device 200 is performed in an area in which high-speed communication is available when communication history information is acquired from the other vehicle ml or a communication state map is acquired from the server device 200.

### [Processing Flow]

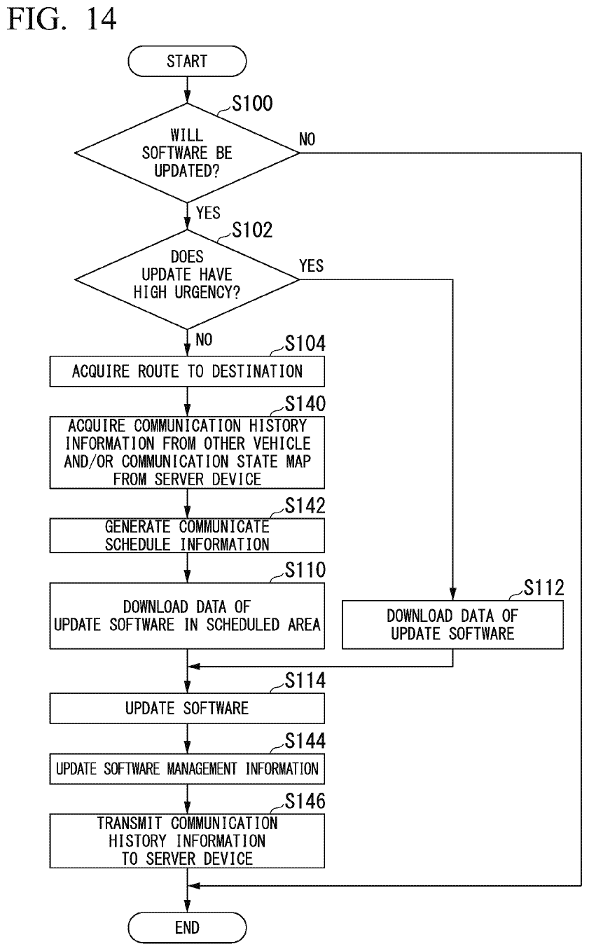

FIG. 14 is a flowchart showing an example of processing of the software updating device 100 of the third embodiment. Processing shown in FIG. 14 differs from processing of the software updating device 100 of the above-described first embodiment in that processes of steps S140 and S142 are included instead of the processes of steps S106 and S108 and processes of steps S144 and S146 are included instead of the process of step S116. Accordingly, description below will chiefly focus on the processes of steps S140 to S146.

In the third embodiment, the update controller 120 performs communication with the other vehicle ml and/or the server device 200 through the communicator 110 after the process of step S104 and acquires a communication state map of an area including a route acquired in the process of step S104 (step S140). Then, the update controller 120 generates communication schedule information on the basis of communication history information acquired from the other vehicle ml and/or the communication state map (step S142) and performs the process of step S110 and subsequent processes.

In the third embodiment, the update controller 120 updates the software management information 162 after the process of step S114 ends (step S144) and transmits communication history information in software update in this occasion to the server device 200 (step S146).

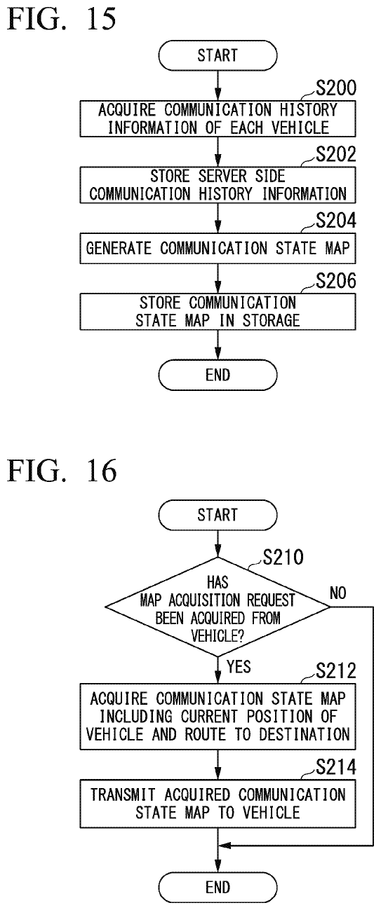

FIG. 15 is a flowchart showing an example of map generation processing in the server device 200 of the third embodiment. The communication history acquirer 242 acquires communication history information from each vehicle via the network NW (step S200) and causes the server side storage 250 to store server side communication history information 252 on the basis of the acquired communication history information (step S202). Then, the map generator 244 performs statistical processing on the server side communication history information, generates a communication state map (step S204), and causes the server side storage 250 to store the generated communication state map (step S206). Accordingly, processing of this flowchart ends.

FIG. 16 is a flowchart showing an example of map providing processing in the server device 200 of the third embodiment. The information provider 246 determines whether a map acquisition request has been acquired from a vehicle (step S210). When the map acquisition request has been acquired, the information provider 246 acquires a communication state map including a current position of the vehicle and a route to a destination (step S212) and transmits the acquired communication state map to the vehicle (step S214). Accordingly, processing of this flowchart ends. In addition, when it is determined that a map acquisition request has not been acquired from the vehicle in the process of step S210, processing of this flowchart ends.

Meanwhile, although an example in which the vehicle M acquires update history information from the other vehicle ml is illustrated in the above-described example, the update controller 120 may transmit update history information stored in the storage 160 to the other vehicle ml when there is an update history information acquisition request from the other vehicle ml.

According to the above-described third embodiment, it is possible to generate more appropriate communication schedule information on the basis of communication history information acquired from another vehicle and/or a communication state map acquired from the server device 200, for example, even when the vehicle M does not have communication history information around the current position thereof. According to the third embodiment, for example, the server device 200 may manage points and areas where communication using a communication method conforming to Wi-Fi can be performed and an instruction for execution of update software download may be transmitted from the server device 200 to the vehicle M when the vehicle M has moved from a cellular network to a Wi-Fi network.

In the third embodiment, the update controller 120 may control a download timing by combining communication history information of another vehicle, a communication state map from the server device 200, and communication history information of the vehicle M. According to the third embodiment, it is possible to change a data transmission/reception timing to a more appropriate timing on the basis of information about a communication state from the other vehicle ml or the server device 200.

Each of the above-described first to third embodiments may be combined with some or all other embodiments. According to each of the above-described embodiments, it is possible to secure real time by performing transmission and reception of data in high-speed communication environments and download data, for example, during an ignition cycle (ignition on state) of the vehicle M. According to each embodiment, transmission and reception of data are not performed deliberately even when low-speed communication is available, and thus it is possible to curb a failure due to communication occupation and also rapidly download a large amount of data. According to each embodiment, it is possible to reduce communication costs even when communication with respect to a large amount of data is performed by setting high priority for a communication method conforming to Wi-Fi and generating a communication schedule. According to embodiments, it is possible to execute reprogramming such as data download and software update at a more appropriate timing in association with destination setting and action prediction. The present embodiment is not limited to update software download and can also be applied to timing adjustment when other types of data (e.g., a large amount of content data) are downloaded.

While forms for carrying out the present invention have been described using the embodiments, the present invention is not limited to these embodiments at all, and various modifications and substitutions can be made without departing from the gist of the present invention.

What is claimed is:

1. A software updating device comprising:
an apparatus controller in which software for controlling at least some of apparatuses mounted in a vehicle is installed;
a communicator configured to communicate with an external device;
an update controller configured to update the software installed in the apparatus controller according to communication with the external device through the communicator; and
a communication state manager configured to manage a communication state between the communicator and the external device,
wherein the update controller causes communication with the external device to be executed in an area in which communication has been performed in a communication state having a predetermined speed or higher from among past communication states managed by the communication state manager.

2. The software updating device according to claim 1, wherein, when a route to a destination of the vehicle has been set by a route guide configured to perform guidance for a route from a current position of the vehicle to a destination, the update controller sets a region in which communication for updating the software will be performed on the route.

3. The software updating device according to claim 1, further comprising an action predictor configured to perform prediction of a future action of the vehicle on the basis of past communication states managed by the communication state manager,
wherein a region in which communication for updating the software will be performed is set on the basis of a future action of the vehicle predicted by the action predictor.

4. The software updating device according to claim 3, wherein the action predictor estimates a state of an occupant of the vehicle from a captured image of the occupant and performs prediction of a future action of the vehicle on the basis of the estimated state of the occupant.

5. The software updating device according to claim 1, further comprising a position acquirer configured to acquire a position of the vehicle,
wherein, when the vehicle is traveling at a position different from positional information included in the past communication states, the communication state manager learns a communication state of the different position on the basis of the position of the vehicle acquired by the position acquirer.

6. The software updating device according to claim 1, wherein the communication state having the predetermined speed or higher includes communication using a communication method conforming to Wi-Fi.

7. The software updating device according to claim 1, wherein, when the communication state is communication using a communication method conforming to Wi-Fi at a specific point and the vehicle stops, the update controller performs communication for updating the software in preference to other communication states.

8. The software updating device according to claim 1, wherein, when the software to be updated is software having high urgency, the update controller performs communication with the external device irrespective of communication states and performs communication for updating the software.

9. The software updating device according to claim 1, wherein the communicator performs communication with another vehicle present around the vehicle, and
when information about a communication state surrounding the vehicle has been acquired from the other vehicle or the external device through the communicator, the update controller sets a region in which communication for updating the software will be performed on the basis of the acquired surrounding communication state.

10. A software updating method, using a computer which realizes a software updating device mounted in a vehicle, comprising:
communicating with an external device;
updating software installed in a controller configured to control at least some of apparatuses mounted in the vehicle through communication with the external device;
managing a communication state with respect to the external device; and
causing communication with the external device to be executed in an area in which communication has been performed in a communication state having a predetermined speed or higher from among managed past communication states.
